(19) United States
(12) Patent Application Publication
(10) Pub. No.: US 2025/0210830 A1
(43) Pub. Date: Jun. 26, 2025

(54) BATTERY CELL AND BATTERY MODULE

(71) Applicant: SAMSUNG SDI CO., LTD., Yongin-si (KR)

(72) Inventors: Shang Chul SEOK, Suwon-si (KR); In Hyeok SONG, Suwon-si (KR)

(21) Appl. No.: 18/944,371

(22) Filed: Nov. 12, 2024

(30) Foreign Application Priority Data
Dec. 21, 2023 (KR) 10-2023-0188697

(51) Int. Cl. H01M 50/586; H01M 10/654; H01M 10/658; H01M 50/204

(52) U.S. Cl. CPC H01M 50/586; H01M 10/654; H01M 10/658; H01M 50/204

(57) ABSTRACT

A battery cell and a battery module are disclosed. A battery cell includes an electrode assembly, a case receiving the electrode assembly, a cap plate coupled to an opening of the case, a terminal arranged to the cap plate and electrically connected to the electrode assembly, and an insulating member between the electrode assembly and the terminal.

### CROSS-REFERENCE TO RELATED APPLICATION

The present application claims priority to and the benefit of Korean Patent Application No. 10-2023-0188697, filed on Dec. 21, 2023 in the Korean Intellectual Property Office, the entire disclosure of which is incorporated herein by reference.

### BACKGROUND

### 1. Field

Aspects of embodiments of the present invention relate to a battery cell and a battery module.

### 2. Description of the Related Art

A battery cell can be charged and discharged unlike a primary cell that cannot be charged. Low-capacity battery cells may be used in small, portable electronic devices, such as smartphones, feature phones, notebook computers, digital cameras, and camcorders, and high-capacity battery cells are widely used as power sources for motors in hybrid and electric vehicles and as power storage cells. Such a battery cell includes an electrode assembly including a cathode and an anode, a case receiving the electrode assembly, and electrode terminals connected to the electrode assembly.

The battery cell contains a highly reactive substance for charging and discharging or can be easily heated by an external environment. In this case, the battery cell can undergo an increase in internal temperature upon occurrence of an electric short due to overcharging or overdischarging. In addition, the battery cell can undergo an increase in internal temperature due to an increase in external temperature.

With advancement of science and increase in concern for the environment, the application range of battery cells has expanded to all electronic devices close to people's daily lives, such as automobiles and smartphones. Therefore, in order to ensure human safety, it is desired to reduce occurrence of fire in battery cells while improving battery cell safety.

This section is intended to provide a better understanding of the background of the invention and thus may include information which is not necessarily prior art.

### SUMMARY

According to an aspect of embodiments of the present invention, a battery cell and/or a battery module using an optimized insulator are provided.

According to another aspect of embodiments of the present invention, a battery cell and/or a battery module capable of reducing an increase in temperature of other battery cells adjacent to the battery cell in the event of an abnormal increase in temperature due to thermal runaway or an internal short circuit of the battery cell are provided. According to another aspect of embodiments of the present invention, a battery cell capable of reducing incidence or suppressing occurrence of fire and/or a battery module including such a battery cell are provided.

The above and other aspects and features of the present invention will become apparent from the following description of some embodiments of the present invention.

According to one or more embodiments of the present invention, a battery cell includes: an electrode assembly; a case receiving the electrode assembly; a cap plate coupled to an opening of the case; a terminal arranged to the cap plate and electrically connected to the electrode assembly; and an insulating member between the electrode assembly and the terminal.

According to one or more embodiments of the present invention, a battery module includes: multiple battery cells; a housing receiving the multiple battery cells; and a busbar electrically connecting at least some of the multiple battery cells, wherein each of the battery cells includes an electrode assembly; a terminal arranged under the busbar and electrically connected to the electrode assembly; and an insulating member between the electrode assembly and the terminal.

According to embodiments of the present invention, the battery cell can reduce an increase in temperature of other battery cells adjacent to the battery cell in the event of an abnormal increase in temperature due to thermal runaway or an internal short circuit of the battery cell.

In addition, according to embodiments of the present invention, the battery cell can suppress the temperature of other battery cells adjacent thereto to a self-reaction temperature of the battery cell in the event of thermal runaway of the battery cell.

Further, according to embodiments of the present invention, the battery cell can suppress the temperature of other battery cells adjacent thereto, thereby reducing an intensity of a fire in the battery module.

Further, according to embodiments of the present invention, combustion of an entire energy storage system (ESS) can be prevented (prevented or substantially prevented), thus preventing transition to a large fire.

However, aspects and features of the present invention are not limited to those described above, and other aspects and features not mentioned will be clearly understood by those skilled in the art from the detailed description provided below.

### BRIEF DESCRIPTION OF THE DRAWINGS

The following drawings attached to this specification illustrate some example embodiments of the present invention, and further describe aspects and features of the present invention together with the detailed description of the present invention. However, the present invention is not to be construed as being limited to the drawings:

FIG. 1 is a view of a battery cell according to an embodiment of the present invention;

FIG. 2 is a cross-sectional view taken along the line II-II of FIG. 1;

FIG. 3 is a view of a battery module according to an embodiment of the present invention;

FIG. 4 is a top view of a cap plate according to an embodiment of the present invention;

FIG. 5 is a perspective view illustrating some components of the battery module according to an embodiment of the present invention;

FIG. 6 is an enlarged exploded perspective view of a region “A” in FIG. 5;

FIG. 7A and FIG. 7B are views illustrating effectiveness of an embodiment of the invention;

FIG. 8 is a view of a battery pack according to an embodiment of the present invention;

FIG. 9 is a view of the battery pack according to an embodiment of the present invention;

FIG. 10 is a perspective a view of a vehicle body and body parts according to an embodiment of the present invention; and

FIG. 11 is a side view of the vehicle body and the body parts according to an embodiment of the present invention.

### DETAILED DESCRIPTION

Herein, some example embodiments of the present invention will be described, in further detail, with reference to the accompanying drawings. The terms or words used in this specification and claims should not be construed as being limited to the usual or dictionary meaning and should be interpreted as having meanings and concepts consistent with the technical idea of the present invention based on the principle that the inventor can be his/her own lexicographer to appropriately define the concept of the term to explain his/her invention in the best way. The embodiments described in this specification and the configurations shown in the drawings are some example embodiments of the present invention and do not necessarily represent all of the technical ideas, aspects, and features of the present invention. Accordingly, it is to be understood that there may be various equivalents and modifications that can replace or modify the embodiments described herein at the time of filing this application. It is to be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. Further, the use of “may” when describing embodiments of the present invention relates to “one or more embodiments of the present invention.”

In the figures, dimensions of the various elements, layers, and the like may be exaggerated for clarity of illustration. The same reference numerals designate the same elements.

References to two compared elements, features, and the like as being “the same,” may mean that they are the same or substantially the same. Thus, the phrase “the same” or “substantially the same” may include a case having a deviation that is considered low in the art, for example, a deviation of 5% or less. In addition, when a certain parameter is referred to as being uniform in a given region, it may mean that it is uniform in terms of an average.

It is to be understood that, although the terms “first,” “second,” “third,” and the like may be used herein to describe various elements, components, regions, layers, and/or sections, these elements, components, regions, layers, and/or sections are not to be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Throughout the specification, unless specified otherwise, each element may be singular or plural.

When an arbitrary element is referred to as being disposed (or placed or positioned) “above” (or “below”) or “on” (or “under”) a component, it may mean that the arbitrary element is placed in contact with the upper (or lower) surface of the component and may also mean that another component may be interposed between the component and any arbitrary element disposed (or placed or positioned) on (or under) the component.

In addition, it is to be understood that, when an element is referred to as being “coupled,” “linked,” or “connected” to another element, the elements may be directly “coupled,” “linked,” or “connected” to each other, or one or more intervening elements may be present therebetween, through which the element may be “coupled,” “linked,” or “connected” to another element. In addition, when a part is referred to as being “electrically coupled” to another part, the part can be directly connected to another part or one or more intervening parts may be present therebetween such that the part and the another part are indirectly connected to each other.

Throughout the specification, when “A and/or B” is stated, it means A, B or A and B, unless specified otherwise. That is, “and/or” includes any or all combinations of multiple items enumerated. When “C to D” is stated, it means C or more and D or less, unless specified otherwise.

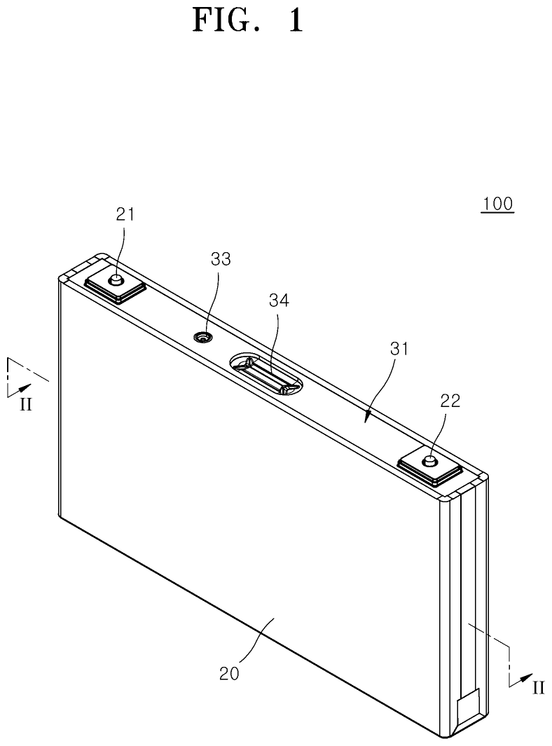

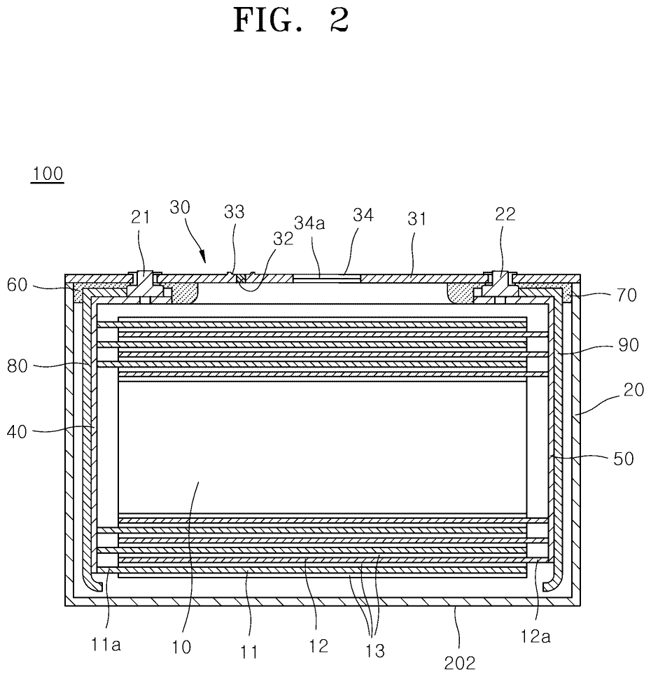

FIG. 1 is a view of a battery cell according to an embodiment of the present invention; and FIG. 2 is a cross-sectional view taken along the line II-II of FIG. 1.

A battery cell 100 according to an embodiment of the present invention may include at least one electrode assembly 10, which includes a cathode (positive electrode) 11, an anode (negative electrode) 12, and a separator 13 interposed therebetween and is in a rolled or wound state, a case 20 receiving the electrode assembly 10 therein, and a cap assembly 30 coupled to an opening of the case 20.

The battery cell 100 according to an embodiment may be a lithium ion battery cell and will be described as a prismatic battery by way of example. However, it is to be understood that the present invention is not limited thereto and may be applied to various types of batteries, such as lithium polymer batteries, cylindrical batteries, and the like. For example, the battery cell according to an embodiment may include any form of battery cell, such as a cylindrical battery cell, a coin type battery cell, a pouch type battery cell, and the like.

Each of the cathode 11 and the anode 12 may include a current collector formed of a thin sheet of metal foil, a coated portion corresponding to a region of the current collector coated with an active material, and an uncoated portion 11a or 12a corresponding to a region of the current collector not coated with an active material. In an embodiment, the cathode 11 and the anode 12 are wound with the separator 13 interposed as an insulator therebetween. However, it is to be understood that the present invention is not limited thereto, and, in an embodiment, the electrode assembly 10 may have a structure in which multiple sheets of cathodes and anodes are alternately stacked with the separator interposed therebetween.

The cathode 11, the anode 12, and the separator 13 will be described in further detail below.

The case 20 defines an overall appearance of the battery cell 100 and may be formed of a conductive metal, such as aluminum, an aluminum alloy, or nickel-plated steel. In addition, the case 20 may define a space in which the electrode assembly 10 is accommodated, or received.

The cap assembly 30 may include a cap plate 31 that covers the opening of the case 20, and the case 20 and the cap plate 31 may be formed of a conductive material. In an embodiment, cathode and anode terminals 21, 22 electrically connected to the cathode 11 and the anode 12 may protrude outward from the cap plate 31 therethrough.

In an embodiment, an upper post of each of the cathode and anode terminals 21, 22 protruding outward from the cap plate 31 may have a threaded outer peripheral surface to be secured to the cap plate 31 with a nut.

However, it is to be understood that the present invention is not limited thereto, and, in an embodiment, each of the cathode and anode terminals 21, 22 may have a rivet structure to allow rivet coupling or may be welded to the cap plate 31.

In an embodiment, the cap plate 31 may be made of a thin plate and coupled to the opening of the case 20 and may be formed with an electrolyte inlet 32, to which a sealing stopper 33 may be provided, and a vent 34 formed with a notch 34a.

The cathode and anode terminals 21, 22 may be electrically connected to current collectors, which include a first current collector 40 and a second current collector 50 (herein referred to as cathode and anode current collectors) welded to a cathode uncoated portion 11a and an anode uncoated portion 12a, respectively.

For example, the cathode and anode terminals 21, 22 may be welded to the cathode and anode current collectors 40, 50. However, it is to be understood that the present invention is not limited thereto, and, in an embodiment, the cathode and anode terminals 21, 22 may be integrally formed with the cathode and anode current collectors 40, 50, respectively.

Further, an insulating member may be interposed between the electrode assembly 10 and the cap plate 31. Here, the insulating member may include first and second lower insulating members 60, 70 each disposed between the electrode assembly 10 and the cap plate 31.

Further, according to an embodiment, a separation member may be disposed between the insulating member and each of the cathode and anode terminals 21, 22 such that an end of the separation member faces a side of the electrode assembly 10.

Here, the separation member may include first and second separation members 80, 90.

Accordingly, the first and second separation members 80, 90 may be disposed between the first and second lower insulating members 60, 70 and the cathode and anode terminals 21, 22, respectively, such that the end of each of the first and second separation members 80, 90 faces a side of the electrode assembly 10.

As a result, the cathode and anode terminals 21, 22 welded to the cathode and anode current collectors 40, 50 may be coupled to the first and second lower insulating members 60, 70 and the corresponding ends of the first and second separation members 80, 90, respectively.

The electrode assembly 10 includes the anode 11, the cathode 12, and the separator 13, as described above. In an embodiment, the electrode assembly 10 is received together with an electrolyte (not shown) within the case 20. These components will be described below in further detail.

### Cathode Material

As a cathode material, a compound enabling reversible intercalation and deintercalation of lithium (lithiated intercalation compound) may be used. In an embodiment, the cathode material may be at least one complex oxide of a metal selected from among cobalt, manganese, nickel and combinations thereof with lithium.

The composite oxide may be a lithium transition metal composite oxide. In an embodiment, the composite oxide may be a lithium nickel oxide, a lithium cobalt oxide, a lithium manganese oxide, a lithium iron phosphate compound, a cobalt-free nickel-manganese oxide, or a combination thereof.

By way of example, the composite oxide may be a compound represented by any of the following formulas: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}CO_{b}X_{c}O_{2-α}D_{α} (0.90≤a≤1.8, O≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L_{d}¹GeO₂ (0.90≤a≤1.8, 0≤b≤0.9, 0≤c≤0.5, 0≤d≤0.5, 0≤e≤0.1); LiₐNiGbO₂ (0.90≤a≤1.8, 0.001≤b≤0.1); LiₐCoGbO₂ (0.90≤a≤1.8, 0.001≤b≤0.1); LiₐMn_{1-b}GbO₂ (0.90≤a≤1.8, 0.001≤b≤0.1); LiₐMn₂GbO₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above formulas, A is Ni, Co, Mn, or a combination thereof; X is Al, Ni, Co, Mn, Cr, Fe, Mg, Sr, V, a rare-earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

By way of example, the cathode material may be a high nickel-content cathode material containing 80 mol % or more, 85 mol % or more, 90 mol % or more, 91 mol % or more, or 94 mol % to 99 mol % of nickel relative to 100 mol % of metal excluding lithium in the lithium transition metal complex oxide. The high nickel-content cathode material can achieve high capacity and can be applied to high capacity/high density lithium battery cells.

### Cathode 10

The cathode 10 for the lithium battery cell 100 may include a current collector and a cathode material layer formed on the current collector. The cathode material layer includes a cathode material and may further include a binder and/or a conductive material.

In an embodiment, the cathode may further include an additive capable of acting as a sacrificial cathode.

In an embodiment, the cathode material may be present in an amount of 90 wt % to 99.5 wt % based on 100 wt % of the cathode material layer, and each of the binder and the conductive material may be present in an amount of 0.5 wt % to 5 wt % based on 100 wt % of the cathode material layer.

The binder attaches cathode material particles to each other while attaching the cathode material to the current collector. The binder may include, for example, any of polyvinyl alcohol, carboxymethylcellulose, hydroxypropylcellulose, diacetylcellulose, polyvinyl chloride, carboxylated polyvinyl chloride, polyvinyl fluoride, polymers including ethylene oxide, polyvinyl pyrrolidone, polyurethane, polytetrafluoroethylene, polyvinylidene fluoride, polyethylene, polypropylene, styrene-butadiene rubbers, (meth)acrylated styrene-butadiene rubbers, epoxy resins, (meth)acrylic resins, polyester resins, Nylon, and the like, without being limited thereto.

The conductive material imparts conductivity to the electrodes and may be any electrically conductive material that does not cause chemical change in cells under construction. The conductive material may include, for example, any of carbon materials, such as natural graphite, artificial graphite, carbon black, acetylene black, Ketjen black, carbon fiber, carbon nanofibers, carbon nanotubes, and the like; metal-based materials in the form of metal powders or metal fibers containing copper, nickel, aluminum, silver, and the like; conductive polymers, such as polyphenylene derivatives and the like; and mixtures thereof.

In an embodiment, the current collector may be aluminum (AI), without being limited thereto.

### Anode Material

The anode material includes a material allowing reversible intercalation/deintercalation of lithium ions, lithium metal, lithium metal alloy, a material capable of being doped to lithium and de-doped therefrom, or a transition metal oxide.

The material allowing reversible intercalation/deintercalation of lithium ions may include a carbon-based anode material, for example, crystalline carbon, amorphous carbon, or a combination thereof. The crystalline carbon may include, for example, graphite, such as natural graphite or artificial graphite, in amorphous, plate, flake, spherical, or fibrous form, and the amorphous carbon may include, for example, any of soft carbon, hard carbon, mesoporous pitch carbides, calcined coke, and the like.

The lithium metal alloy may be an alloy of lithium, and a metal selected from among Na, K, Rb, Cs, Fr, Be, Mg, Ca, Sr, Si, Sb, Pb, In, Zn, Ba, Ra, Ge, Al, and Sn may be used.

The material capable of being doped to lithium and de-doped therefrom may be an Si-based anode material or an Sn-based anode material. The Si-based anode material may be silicon, a silicon-carbon composite, SiOₓ(0<x<2), Si-Q alloys (where Q is selected from among alkali metals, alkali-earth metals, Group XIII elements, Group XIV elements (excluding Si), Group XV elements, Group XVI elements, transition metals, rare-earth elements, and combinations thereof), or combinations thereof. The Sn-based anode material may be Sn, SnO₂, an Sn alloy, or a combination thereof.

The silicon-carbon composite may be a composite of silicon and amorphous carbon. According to an embodiment, the silicon-carbon composite may be prepared in the form of silicon particles having an amorphous carbon coating formed on the surface thereof. For example, the silicon-carbon composite may include secondary particles (cores) composed of primary silicon particles and an amorphous carbon coating layer (shell) formed on the surface of the secondary particles. The amorphous carbon may also be placed between the primary silicon particles such that, for example, the primary silicon particles are coated with amorphous carbon. The secondary particles may be dispersed in an amorphous carbon matrix.

The silicon-carbon composite may further include crystalline carbon. For example, the silicon-carbon composite may include a core containing crystalline carbon and silicon particles, and an amorphous carbon coating layer formed on the core.

The Si-based anode material or the Sn-based anode material may be used in combination with the carbon-based anode material.

### Anode 20

The anode 20 for the lithium battery cell 100 may include a current collector and an anode material layer formed on the current collector. The anode material layer includes an anode material and may further include a binder and/or a conductive material.

For example, the anode material layer may include 90 wt % to 99 wt % of the anode material, 0.5 wt % to 5 wt % of the binder, and 0 wt % to 5 wt % of the conductive material.

The binder attaches the anode material particles to each other while attaching the anode material to the current collector. The binder may be a non-aqueous binder, an aqueous binder, a dry binder, or a combination thereof.

In an embodiment, the non-aqueous binder includes any of polyvinyl chloride, carboxylated polyvinyl chloride, polyvinyl fluoride, ethylene propylene copolymers, polystyrene, polyurethane, polytetrafluoroethylene, polyvinylidene fluoride, polyethylene, polypropylene, polyamideimide, polyimide, or combinations thereof.

The aqueous binder may be selected from the group consisting of styrene-butadiene rubbers, (meth)acrylated styrene-butadiene rubbers, (meth)acrylonitrile-butadiene rubbers, (meth)acrylic rubbers, butyl rubbers, fluorinated rubbers, polyethylene oxide, polyvinyl pyrrolidone, polyepichlorohydrin, polyphosphazene, poly(meth)acrylonitrile, ethylene propylene diene copolymers, polyvinyl pyridine, chlorosulfonated polyethylene, latex, polyester resins, (meth)acryl resins, phenol resins, epoxy resins, polyvinyl alcohol, and combinations thereof.

When the aqueous binder is used as the anode binder, a cellulose-based compound capable of imparting viscosity may be further included. The cellulose-based compound may be a mixture of carboxymethylcellulose, hydroxypropyl methylcellulose, methylcellulose, or alkali metal salts thereof. The alkali metal may be Na, K, or Li.

The dry binder may be a fibrous polymeric material and may include, for example, polytetrafluoroethylene, polyvinylidene fluoride, a polyvinylidene fluoride-hexafluoropropylene copolymer, polyethylene oxide, or a combination thereof.

The conductive material imparts conductivity to the electrodes and may be any electronically conductive material that does not cause chemical change in cells under construction. In an embodiment, the conductive material may include, for example, any of carbon materials, such as natural graphite, artificial graphite, carbon black, acetylene black, Ketjen black, carbon fibers, carbon nanofibers, carbon nanotubes, and the like; metal-based materials in the form of metal powders or metal fibers containing copper, nickel, aluminum, silver, and the like; conductive polymers, such as polyphenylene derivatives and the like; or mixtures thereof.

In an embodiment, the anode current collector may be selected from copper foil, nickel foil, stainless steel foil, titanium foil, nickel foam, copper foam, a conductive metal-coated polymer base, and combinations thereof.

Electrolyte (not shown)

In an embodiment, the electrolyte for the lithium battery cell 100 includes a non-aqueous organic solvent and a lithium salt.

The non-aqueous organic solvent acts as a medium through which ions involved in electrochemical reaction of a cell can move.

In an embodiment, the non-aqueous organic solvent may be a carbonate-based solvent, an ester-based solvent, an ether-based solvent, a ketone-based solvent, an alcohol-based solvent, a non-amphoteric solvent, or a combination thereof.

The carbonate-based solvents may include dimethyl carbonate (DMC), diethyl carbonate (DEC), dipropyl carbonate (DPC), methyl propyl carbonate (MPC), ethyl propyl carbonate (EPC), methyl ethyl carbonate (MEC), ethylene carbonate (EC), propylene carbonate (PC), butylene carbonate (BC), and the like.

The ester-based solvents may include methyl acetate, ethyl acetate, n-propyl acetate, dimethyl acetate, methyl propionate, ethyl propionate, decanolide, mevalonolactone, valerolactone, caprolactone, and the like.

The ether-based solvents may include dibutyl ether, tetraglyme, diglyme, dimethoxyethane, 2-methyltetrahydrofuran, 2,5-dimethyltetrahydrofuran, tetrahydrofuran, and the like. In addition, the ketone-based solvent may include cyclohexanone and the like. The alcohol-based solvents may include ethyl alcohol, isopropyl alcohol, and the like, and non-amphoteric solvent may include nitriles, such as R-CN (where R is a straight, branched or cyclic hydrocarbon group having 2 to 20 carbon atoms and may include double bonds, aromatic rings, or ether groups); amides, such as dimethylformamide; dioxolanes, such as 1,3-dioxolane, 1,4-dioxolane; sulfolanes; and the like.

The non-aqueous organic solvent may be used alone or as a mixture thereof.

In an embodiment, in use of the carbonate-based solvent, a mixture of a cyclic carbonate and a chained carbonate may be used, and the cyclic carbonate and the chained carbonate may be mixed in a volume ratio of 1:1 to 1:9.

The lithium salt is a substance soluble in an organic solvent and serves as a source of lithium ions in a battery, enabling operation of a basic lithium battery cell while facilitating transfer of the lithium ions between the cathode and the anode. Examples of the lithium salts may include at least one selected from among LiPF₆, LiBF₄, LiSbF₆, LiAsF₆, LiClO₄, LiAlO₂, LiAlCl₄, LIPO₂F₂, LICl, Lil, LiN(SO₃C₂F₅)₂, Li(FSO₂)₂N(lithium bis(fluorosulfonyl)imide (LiFSl), LiC₄F₉SO₃, LiN(CₓF₂ₓ₊₁SO₂) (C_{y}F_{2y+1}SO₂) (where x and y are integers of 1 to 20), lithium trifluoromethane sulfonate, lithium tetrafluoroethane sulfonate, lithium difluorobis(oxalato)phosphate (LiDFOB), and lithium bis(oxalato) borate (LiBOB).

### Separator 30

Depending on the type of lithium battery cell 100, the separator 30 may be interposed between the cathode 10 and the anode 20. For such a separator 30, polyethylene, polypropylene, polyvinylidene fluoride, or two or more layers thereof may be used as well as mixed layers, such as a polyethylene/polypropylene bilayer separator, a polyethylene/polypropylene/polyethylene trilayer separator, a polyethylene/polyethylene/polypropylene trilayer separator, and the like.

The separator 30 may include a porous substrate and a coating layer that includes an organic material, an inorganic material, or a combination thereof on one or both surfaces of the porous substrate.

The porous substrate may be a polymer layer formed of a polymer selected from among polyolefins, such as polyethylene, polypropylene, and the like, polyesters, such as polyethylene terephthalate, polybutylene terephthalate, and the like, polyacetal, polyamides, polyimides, polycarbonates, polyether ketones, polyarylether ketones, polyetherimides, polyamideimides, polybenzimidazole, polyethersulfone, polyphenylene oxides, cyclic olefin copolymers, polyphenylene sulfides, polyethylene naphthalate, glass fiber, Teflon, and polytetrafluoroethylene, copolymers thereof, or mixtures thereof.

The organic material may include a polyvinylidene fluoride polymer or a (meth)acrylic polymer.

The inorganic material may include inorganic particles selected from among Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof, without being limited thereto.

The organic material and the inorganic material may be present in a mixed state in one coating layer or may be present in the form of a stack structure of a coating layer including the organic material and a coating layer including the inorganic material.

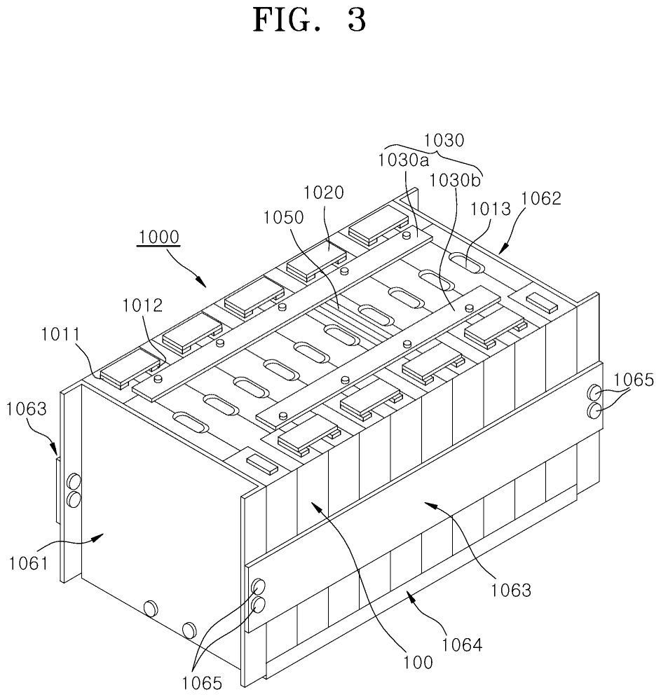

FIG. 3 is a view of a battery module according to an embodiment of the present invention.

A battery module 1000 according to an embodiment of the present invention includes multiple battery cells 100, a housing 1061, 1062, 1063, 1064, 1065 in which the multiple battery cells 100 are received, and busbars electrically connecting at least some of the multiple battery cells 100 to each other.

The multiple battery cells 100 may include, for example, the battery cell illustrated in FIG. 1 and FIG. 2 and may be arranged in a direction to be received in the housing 1061 to 1065.

The housing 1061 to 1065 may include a pair of end plates 1061, 1062 facing wide surfaces of the battery cells 100, and side plates 1063 and a bottom plate 1064 each connecting the pair of end plates 1061, 1062 to each other. The side plates 1063 may support side surfaces of each of the battery cells 100, and the bottom plate 1064 may support a bottom surface of each of the battery cells 10. In addition, the pair of end plates 1061, 1062, the side plates 1063 and the bottom plate 1064 may be connected to one another by members, such as bolts 1065 or the like.

The battery module 100 includes electrodes (or terminals) 1011, 1012, connection tabs 1020 connecting adjacent battery cells 100 to each other, and a protection circuit module 1030 connected at a side thereof to the connection tabs 1020. The protection circuit module 1030 may be a battery management system (BMS). The connection tabs 1020 may be busbars.

Each of the battery cells 100 may be provided at a side thereof with terminals 1011, 1012 electrically connected to the connection tab 1020 and may be formed with a vent 1013, which is a discharge channel of a gas generated therein. The terminals 1011, 1012 of the battery cell 100 may be a cathode terminal 1011 and an anode terminal 1012, respectively, and the terminals 1011, 1012 of adjacent battery cells 100 may be electrically connected in series or in parallel by the connection tab 1020 described below. Although series connection is described by way of example, it is to be understood that various connection structures may be used. In addition, it is to be understood that a number and arrangement of battery cells are not limited to the structure of FIG. 3 and may be changed, as desired.

The protection circuit module 1030 may have electronic components and protection circuits mounted thereon and may be electrically connected to the connection tabs 1020 described below. In an embodiment, the protection circuit module 1030 may include a first protection circuit module 1030a and a second protection circuit module 1030b extending from different locations in an arrangement direction of the battery cells 100, in which the first protection circuit module 1030a and the second protection circuit module 1030b may be spaced apart parallel to each other by a distance (e.g., a constant distance) and each may be electrically connected to the connection tabs 1020 adjacent thereto. For example, the first protection circuit module 1030a extends at a side of upper portions of the multiple battery cells 100 in an arrangement direction of the battery cells 100, and the second protection circuit module 1030b extends at another side of the upper portion of the battery cells 100 in the arrangement direction of the battery cells 100, such that the second protection circuit module 1030b is spaced apart from the first protection circuit module 1030a, with the vents 13 disposed therebetween, while being parallel to the first protection circuit module 1030a. As such, the two protection circuit modules 1030a and 1030b are spaced apart from each other along the arrangement direction of the battery cells 100, thereby minimizing or reducing an area of a printed circuit board (PCB) constituting the protection circuit module 1030. An unnecessary PCB area is minimized or reduced by dividing the protection circuit module 1030 into two separate protection circuit modules. In an embodiment, the first protection circuit module 1030a and the second protection circuit module 1030b may be connected to each other by a conductive connection member 1050. Here, the connection member 1050 is connected at a side thereof to the first protection circuit module 1030a and at another side thereof to the second protection circuit module 1030b, whereby the two protection circuit modules 1030a and 1030b can be electrically connected.

In an embodiment, the connection may be realized by any of soldering, resistance welding, laser welding, or projection welding.

The connection member 1050 may be, for example, an electrical wire. In addition, the connecting member 1050 may be made of an elastic or flexible material. By such a connection member 1050, the voltage, temperature, and current of the multiple battery cells 100 can be checked and managed to be normal. That is, information, such as voltage, current, and temperature received by the first protection circuit module 1030a from the connection tabs adjacent thereto, and information, such as voltage, current, and temperature, received by the second protection circuit module 1030b from the connection tabs adjacent thereto may be integrated and managed by the protection circuit module through the connection member.

In addition, upon swelling of the battery cells 100, impact can be absorbed by elasticity or flexibility of the connection member 1050 to prevent or substantially prevent damage to the first and second protection circuit modules 1030a, 1030b.

However, a shape and structure of the connecting member 1050 are not limited to those shown in FIG. 3.

In this way, the structure of the protection circuit module 1030 divided into the first and second protection circuit modules 1030a, 1030b can secure an interior space of the battery module by minimizing or reducing the area of the PCB that constitutes the protection circuit module. This structure improves work efficiency by facilitating not only operation of connecting the connection tabs 1020 to the protection circuit module 1030, but also repair upon detection of failure of the battery module.

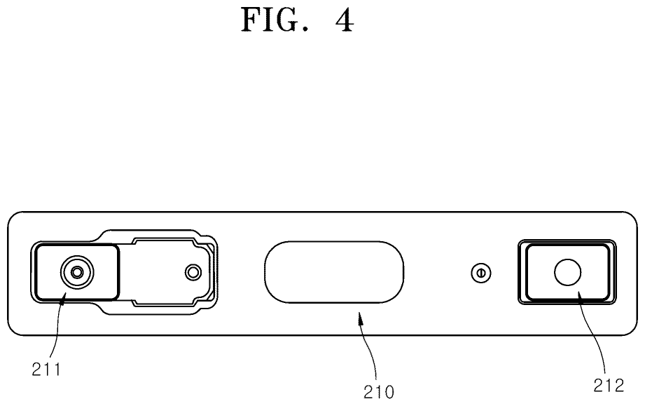

FIG. 4 is a top view of a cap plate according to an embodiment of the present invention.

Referring to FIG. 1 to FIG. 3, the battery cell 100 and the battery module 1000 according to one or more embodiments of the present invention have been described above. As described above, the battery module 1000 includes multiple battery cells 100, at least some of which are electrically connected by busbars. If an abnormal phenomenon, such as thermal runaway or the like, occurs due to increase in temperature of at least one of the multiple battery cells 100, battery cells adjacent to that battery cell 100 may also undergo an increase in temperature. In this case, a fire in the battery module 1000 can be amplified and/or a large fire can occur in the battery module 1000.

Addressing such a problem, embodiments of the present invention provide a structure capable of preventing or substantially preventing a cascade increase in temperature of adjacent battery cells caused by a certain battery cell 100. Such a structure will herein be referred to as an “insulating member.”

The insulating member prevents or substantially prevents heat propagation between adjacent battery cells 100 not only by the characteristics thereof, but also by an installation location thereof.

Referring to FIG. 4, a cap plate corresponding to a space provided with such an insulating member will be described in further detail.

In FIG. 4, reference numeral 210 denotes the cap plate. The cap plate 210 may include the cap plate 31 illustrated in FIG. 1 and FIG. 2.

As illustrated in FIG. 1 to FIG. 3, the battery cell 100 includes an electrode assembly 10, a case 20 receiving the electrode assembly 10 therein, a cap plate 210 coupled to the opening of the case 20, and terminals 211, 212 (including, for example, the cathode terminal 21 and the anode terminal 22 illustrated in FIG. 1 and FIG. 2) provided to the cap plate 210 and electrically connected to the electrode assembly 10.

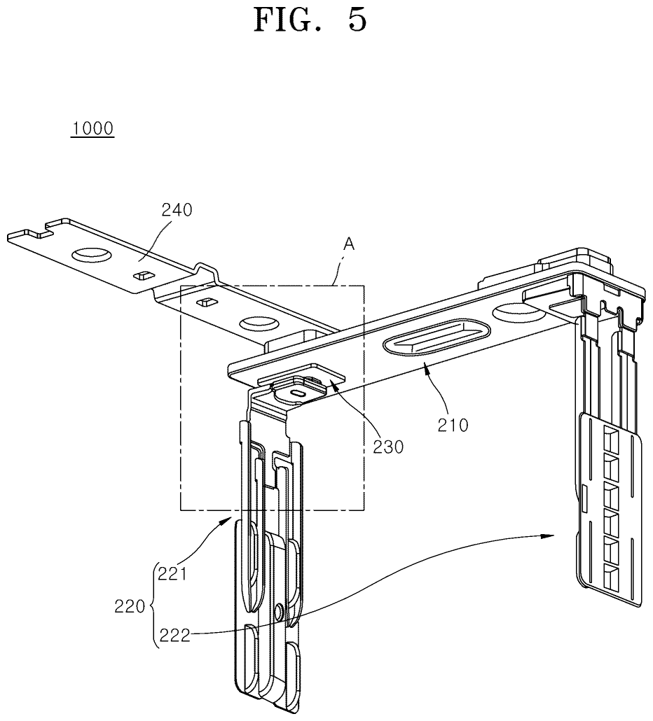

The battery cell 100 further includes insulating members 230 (see FIG. 5) disposed between the electrode assembly 10 and the terminals 211, 212.

The electrode assembly 10 includes a first electrode, a second electrode having different polarity than the first electrode, and a separator 13 interposed between the first and second electrodes. The first electrode includes, for example, the cathode 11, and the second electrode includes, for example, the anode 12. Alternatively, the first electrode may include the anode 12 and the second electrode may include the cathode 11. In an embodiment, the electrode assembly 10 has a jelly roll shape in which the first electrode, the second electrode, and the separator are rolled or wound around each other, or a stack shape in which the first electrode, the second electrode, and the separator are stacked one above another.

The cap plate 31 is coupled to the opening of the case 20 in which the electrode assembly 10 is received. The cap plate 31 includes the terminals 211, 212 at sides thereof corresponding to the electrodes included in the electrode assembly 10.

The terminals 211, 212 include a first terminal 211 electrically connected to the first electrode 11 and a second terminal 212 electrically connected to the second electrode 12. For example, the first terminal 211 may be disposed at a side of the cap plate 31 that can be easily electrically connected to the first electrode 11. Further, the second terminal 212 may be disposed, for example, at a side of the cap plate 32 that can be easily electrically connected to the second electrode 12.

As such, the first electrode 11 and the second electrode 12 included in the electrode assembly 10 may be electrically connected to an exterior of the battery cell 100 through the terminals 211, 212. In this case, however, the battery cell 100 may allow heat transfer through the terminals 211, 212.

Thus, according to an embodiment of the present invention, the insulating member 230 is disposed between the electrodes 11, 12 and the terminals 211, 212. For example, the insulating member 230 may be disposed between the first electrode 11 and the first terminal 211 and/or between the second electrode 12 and the second terminal 212.

With such a structure, the battery cell 100 and/or the battery module 1000 including such battery cells 100 according to embodiments of the present invention can prevent or substantially prevent heat propagation between adjacent battery cells 100. Further, the battery cell according to embodiments of the present invention can prevent or substantially prevent occurrence of fire in the battery module 1000 and/or can reduce the magnitude of any fire.

Next, the insulating member 230 will be described in further detail.

FIG. 5 is a perspective view illustrating some components of the battery module according to an embodiment of the present invention.

FIG. 5 shows some components of the battery module 1000 to illustrate a location of the insulating member 230. FIG. 5 shows the cap plate 210, collector plates 220, the insulating member 230, and a busbar 240 (including, for example, the busbar illustrated in FIG. 3) in the battery module 1000.

As described with reference to FIG. 1 to FIG. 4, the battery cell 100 includes the case 20 and the electrode assembly 10 received within the case 20. Further, the battery cell 100 includes the cap plate 210 coupled to the opening of the case 20. Here, the cap plate 210 may be formed with the terminals 211, 212.

The terminals 211, 212 may be electrically coupled to the electrode assembly 10 through the collector plates 220 (including, for example, the first and second current collectors 40, 50 illustrated in FIG. 1 and FIG. 2). For example, the collector plates 220 may include the first collector plate 221 electrically connected to the first electrode 11 and the second collector plate 222 electrically connected to the second electrode 12. For example, the first terminal 211 is electrically connected to the first electrode 11 through the first collector plate 221, and the second terminal 212 is electrically connected to the second electrode 12 through the second collector plate 222.

In addition, the terminals 211, 212 may be electrically connected to the busbars 240. For example, the busbars 240 may electrically connect the multiple battery cells 100 through the terminals 211, 212.

However, in this case, the busbars 240 may facilitate heat propagation between the battery cells 100, which are electrically connected to and/or placed adjacent to each other. For example, when heat is generated from one battery cell 100, heat can be transferred to an adjacent battery cell 100 through the busbars 240.

Accordingly, the insulating member 230 may be placed between the terminals 211, 212 and the collector plates 220. For example, the insulating member 230 may be placed between the first terminal 211 and the first collector plate 221 and/or between the second terminal 212 and the second collector plate 222. Thus, the insulating member 230 can prevent or substantially prevent heat propagation from one battery cell 100 to other battery cells adjacent thereto through the busbars 240.

To this end, the insulating member 230 includes any suitable material having insulating properties. For example, the insulating member 230 may include at least one of a polymer material, an inorganic material, an organic material, an aerogel, ceramic wool, glass wool, mica, or a combination thereof. Bonding therebetween may include chemical bonding or physical bonding. Physical bonding may include a stack of layers composed of these materials or a mixture of these materials.

The polymer materials include at least one of, for example, polyurethane, polystyrene, polyvinyl alcohol, polymethyl methacrylate (PMMA), polyactic acid (PLA), polyethylene oxide (PEO), polyvinyl acetate, polyacrylic acid (PAA), polyacrylonitrile (PAN), poly(methyl methacrylate) (PMMA), polyvinyl pyrrolidone (PVP), polyvinyl chloride (PVC), Nylon, polycarbonate (PC), polyetherimide (PEI), polyvinylidene fluoride (PVdF), polyetherimide (PEI), and polyester sulfone (PES). In an embodiment, these polymer materials may form the insulating member 230 together with a solvent and/or may form the insulating member 230 in the form of fibers (or nanofibers).

The inorganic material includes at least one of, for example, a glass material including glass wool, a mineral material including asbestos, rock wool, perlite, and the like, silica, silicate, silicic acid, a metallic material including alumina, and the like, and a carbon material including carbon, graphite, and the like. In an embodiment, these inorganic materials may form the insulating member 230, for example, in the form of fibers (or nanofibers).

The organic material includes at least one of, for example, hemp, jute, and cellulose. Further, such organic materials may form the insulating member 230, for example, in the form of fibers (or nanofibers).

In an embodiment, the insulating member 230 may further include a solvent and/or a binder to maintain the shape thereof and/or to allow the respective materials contained within the insulating member 230 to be mixed efficiently.

The solvent includes at least one of, for example, water, dimethyl acetamide (DMA), N,N-dimethylformamide (DMF), N-methyl-2-pyrrolidinone (NMP), dimethyl sulfoxide (DMSO), tetra-hydrofuran (THF), di-methylacetamide (DMAc), ethylene carbonate (EC), diethyl carbonate (DEC), dimethyl carbonate (DMC), ethyl methyl carbonate (EMC), propylene carbonate (PC), and acetone. In an embodiment, the insulating member 230 may be formed without the solvent or the binder.

With such a configuration, the battery cell 100 and/or the battery module 1000 including the multiple battery cells 100 according to embodiments of the present invention can effectively prevent or substantially prevent heat propagation between the battery cells 100 and/or can reduce occurrence of fire in the battery module 1000.

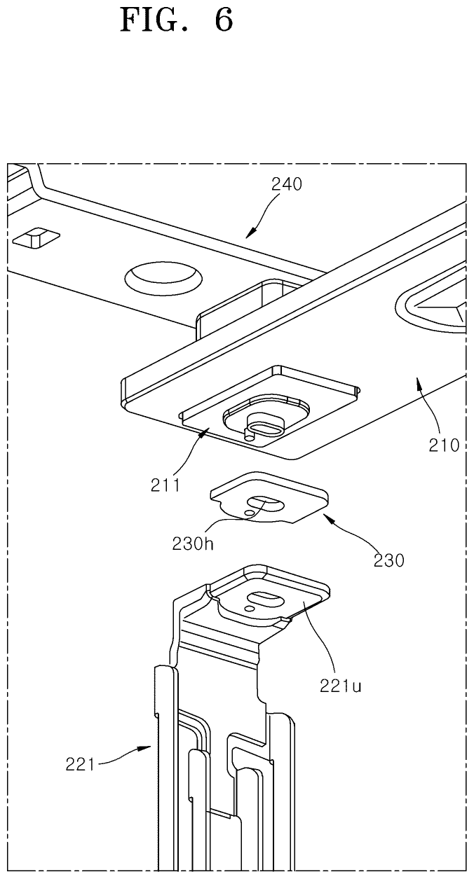

FIG. 6 is an enlarged exploded perspective view of a region “A” in FIG. 5.

Referring to FIG. 6, the insulating member 230 shown in FIG. 5 will be described in further detail. For convenience of description, only the first terminal 211, the first collector plate 221 electrically connected to the first terminal 211, and the insulating member 230 placed between the first terminal 211 and the first collector plate 221 are shown in FIG. 6. However, the features illustrated in FIG. 6 may be equally or similarly applicable to the second terminal 212, the second collector plate 222, and the insulating member placed between the second terminal 212 and the second collector plate 222.

The insulating member 230 includes a through-hole 230h through which the electrode assembly 10 is electrically connected to the terminal 211 or 212.

As described above, the first terminal 211 and the first collector plate 221 are electrically connected to each other, whereby the battery cell 100 can be charged or discharged. The insulating member 230 is formed with the through-hole 230h to prevent or substantially prevent heat propagation between the first terminal 211 and the first collector plate 221 while allowing the first terminal 211 and the first collector plate 221 to be electrically connected to each other. Referring again to FIG. 6, although the through-hole 230h is shown as having a circular shape, it is to be understood that the through-hole 230h may be formed having any suitable shape or size so long as the through-hole can provide a passage through which the first terminal 211 and the first collector plate 221 are electrically connected to each other.

The insulating member 230 may have a surface adjoining a surface 221u of the collector plate at a side of the collector plate. In this case, the surface of the insulating member 230 may have a same or similar cross-sectional area as the surface 221u of the collector plate or may have a larger cross-sectional area than the surface 221u of the collector plate. Here, the surface 221u of the collector plate may refer to a surface of the collector plate adjoining the insulating member 230 among an entire region of the collector plate.

In an embodiment, for example, the insulating member 230 may have a cross-sectional area that is 90% to 300% of the cross-sectional area of the surface 221u of the collector plate at the side thereof. Here, the cross-sectional area of the insulating member 230 is an area of the insulating member 230 facing the surface 221u of the collector plate. Alternatively, for example, the insulating member 230 may have a cross-sectional area that is 90% to 250% of the cross-sectional area of the one surface 221u of the collector plate. In another embodiment, for example, the insulating member 230 may have a cross-sectional area that is 90% to 200% of the cross-sectional area of the surface 221u of the collector plate. In another embodiment, for example, the insulating member 230 may have a cross-sectional area that is 100% to 300% of the cross-sectional area of the surface 221u of the collector plate. In another embodiment, for example, the insulating member 230 may have a cross-sectional area that is 100% to 250% of the cross-sectional area of the surface 221u of the collector plate. In another embodiment, for example, the insulating member 230 may have a cross-sectional area that is 100% to 200% of the cross-sectional area of the surface 221u of the collector plate. With this structure, the insulating member 230 can effectively prevent or substantially prevent heat propagation from the collector plate 220 to the busbar 240 through the terminal 211.

The insulating member 230 may be formed in any suitable shape. For example, the insulating member 230 may be formed corresponding to the shape of the terminal 211, 212 and/or to the surface 221u of the collector plate at the side thereof, as shown in FIG. 6.

The battery cell 100 is desired to be maintained at a certain temperature (e.g., a predetermined temperature) or less for stability. The certain temperature is a temperature at which the battery cell 100 does not ignite, that is, a self-reaction temperature of the battery cell 100. In an embodiment, the certain temperature is, for example, 50° C. or less. However, the certain temperature may be varied depending on products adopting the battery cell 100, environments, or specifications of the battery cell 100. The insulating member 230 may be formed to a thickness in a certain range (e.g., a predetermined range) such that the temperature of the battery cell 100 adjacent to an igniting battery cell 100 becomes the certain temperature or less.

The degree of heat propagation between the battery cells 100 is further reduced with increasing thickness of the insulating member 230. However, if the insulating member 230 becomes increasingly thick, there can be a problem that the size of the battery module 1000 becomes excessively large. Accordingly, the insulating member 230 may be formed to a thickness within a certain range (e.g., a predetermined range).

Accordingly, the insulating member 230 may be formed to a thickness within a certain range. In an embodiment, for example, the insulating member 230 may be formed to a thickness of 0.8 mm or more. For example, the insulating member 230 may be formed to a thickness of 0.8 mm to 2.0 mm. For example, the insulating member 230 may be formed to a thickness of 0.8 mm to 1.8 mm. For example, the insulating member 230 may be formed to a thickness of 0.8 mm to 1.6 mm. For example, the insulating member 230 may be formed to a thickness of 0.8 mm to 1.4 mm. For example, the insulating member 230 may be formed to a thickness of 0.8 mm to 1.2 mm.

In an embodiment, for example, the insulating member 230 may be formed to a thickness of 1.0 mm or more. For example, the insulating member 230 may be formed to a thickness of 1.0 mm to 2.0 mm. For example, the insulating member 230 may be formed to a thickness of 1.0 mm to 1.8 mm. For example, the insulating member 230 may be formed to a thickness of 1.0 mm to 1.6 mm. For example, the insulating member 230 may be formed to a thickness of 1.0 mm to 1.4 mm. For example, the insulating member 230 may be formed to a thickness of 1.0 mm to 1.2 mm.

As such, the battery cell 100 and/or the battery module 1000 including multiple battery cells 100 according to embodiments of the present invention can effectively prevent or substantially prevent heat propagation between the battery cells 100. In particular, the battery cell 100 according to embodiments of the present invention can prevent or substantially prevent heat propagation between the battery cells 100 through the busbar 240. As a result, the battery cell 100 according to embodiments of the present invention can secure that the temperature of adjacent battery cells is less than or equal to the self-reaction temperature and/or can reduce the intensity of fire in the battery module 1000. Accordingly, the battery cell 100 according to embodiments of the present invention can prevent or substantially prevent occurrence of significant fire.

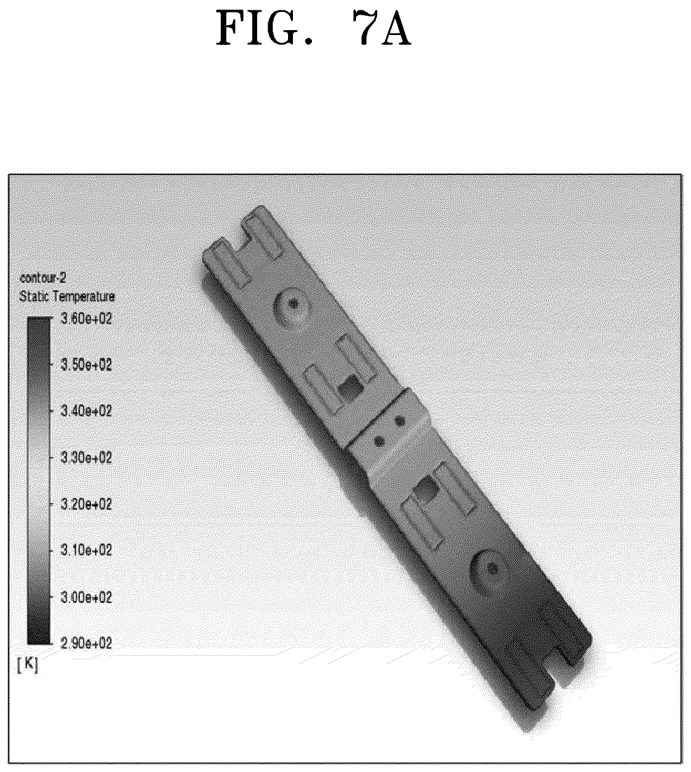

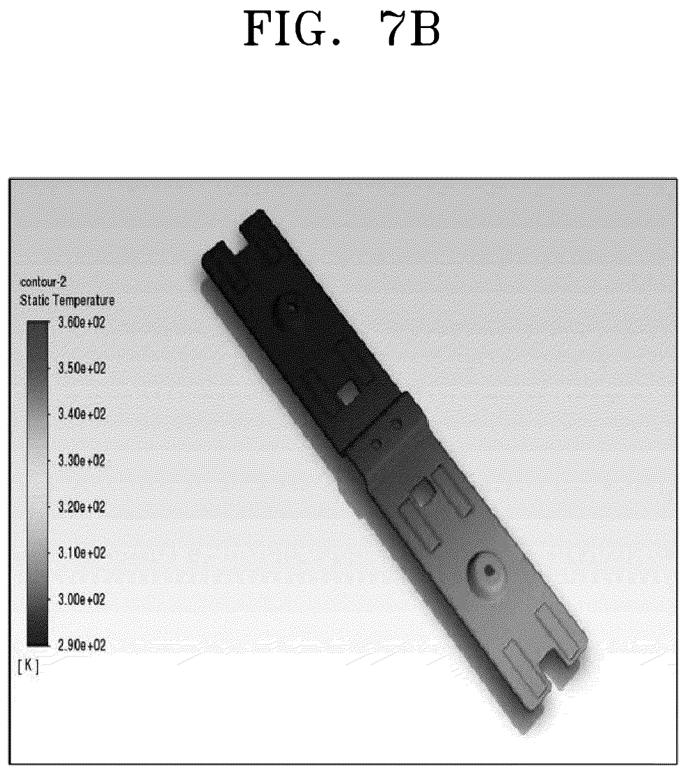

FIG. 7A and FIG. 7B are views illustrating effectiveness of an embodiment of the present invention.

FIG. 7A and FIG. 7B illustrate results of an experiment to determine a degree of heat propagation of busbars in the event of thermal runaway in a single cell. FIG. 7A shows a comparative example of a conventional busbar; and FIG. 7B shows an example of a busbar 240 according to an embodiment of the present invention.

The experiment to determine the degree of heat propagation of the busbar was conducted under the following conditions. The temperature of a collector plate connected to a battery cell in which thermal runaway occurred was set to 773.15 K. In addition, heat propagation was allowed to occur in a free convection state. In the example, a busbar 240 was formed to a thickness of 1 mm and insulated by an insulating member 230 including mica. Here, a cross-sectional area of the insulating member 230 was 80% or more of a surface of the collector plate at a side of the collector plate. This structure allows the insulating member 230 to efficiently block heat propagation between the battery cells 100.

FIG. 7A and FIG. 7B show measurement results of the temperatures of the busbars under thermal equilibrium (saturation) conditions, with the temperature of the collector plate set to 773.15 K.

As a result of the experiment, the busbar of the comparison example had an average temperature of 320.6 K and the busbar of the example had an average temperature of 301.2 K. From this result, it could be seen that the insulating member 230 according to the embodiment of the present invention efficiently blocked heat propagation between battery cells 100 through the busbar 240 in the event of thermal runaway of a certain battery cell.

Further, although not shown in the drawings, the battery module 1000 according to an embodiment of the present invention may further include an additional insulating member disposed in at least one region between the battery cells 100. The additional insulating member may have, for example, a thin sheet shape and/or a structure having a certain thickness (e.g., a predetermined thickness) or more. The additional insulating member may include at least one of, for example, mica, aerogel, silica, graphite, alumina, ceramic wool, and silicate. With this structure, the battery module 1000 can more efficiently prevent heat propagation between adjacent battery cells 100.

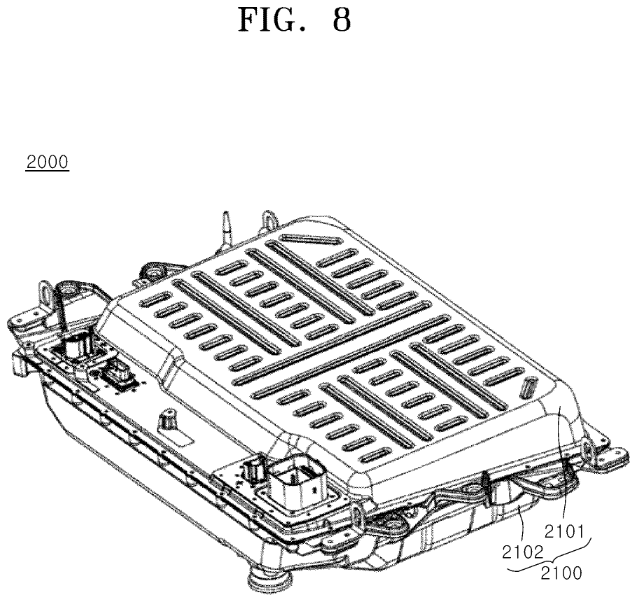

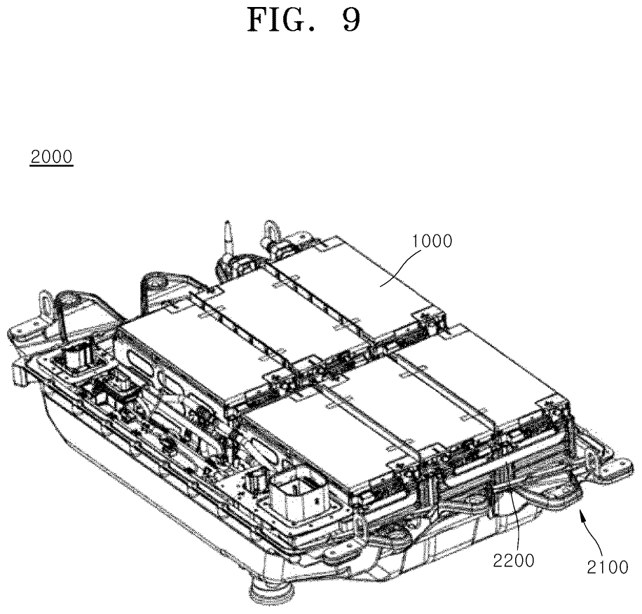

FIG. 8 is a view of a battery pack according to an embodiment of the present invention; and FIG. 9 is a view of the battery pack according to an embodiment of the present invention.

A battery pack 2000 according to an embodiment of the present invention includes an aggregate of individual batteries electrically connected to each other and a pack case receiving the batteries. For convenience of illustration, components, such as a busbar, a cooling unit, and an external terminal for electrical connection of the batteries are not shown.

The battery pack 2000 may include multiple battery modules 1000 (including, for example, the battery modules 1000 illustrated in FIG. 3 to FIG. 7B) and a pack case 2100 receiving the battery modules 1000 therein. The battery module 1000 may include the battery cells 100 illustrated in FIG. 1 to FIG. 7B, as described above.

The multiple battery modules 1000 may be connected to each other in series or in parallel.

For example, the pack case 2100 may include first and second pack cases 2101, 2102 coupled to each other so as to face each other with the multiple battery modules 1000 interposed therein or therebetween. The multiple battery modules 1000 may be electrically connected to each other through busbars 2200 and may be electrically connected to each other in series/parallel or in a mixed series/parallel manner to achieve a desired electrical output.

Although not shown in the drawings, the battery pack 2000 may further include a cooling member to inhibit degradation of the battery cell 100. In an embodiment, the cooling member may be disposed at a lower portion of a compartment in which the battery cells 100 are received, without being limited thereto.

In another embodiment, the cooling member may be disposed at an upper portion of the compartment or on a side surface thereof depending on the battery pack 2000.

Although not shown in the drawings, the battery pack 2000 may include a battery management device (BMS) for managing the battery cells 100 and/or the battery module 1000. In an embodiment, the battery management device may include a detection device, a balancing device, and a control device.

Although not shown in the drawings, the battery pack 2000 may include a detection device. The detection device may detect a state (voltage, current, temperature, or the like) of the battery pack 2000 to detect state information indicative of the state of the battery pack 2000. The detection device may detect a voltage of each of the battery cells 100 or the battery modules 1000 constituting the battery pack 2000. The detection device may also detect a current flowing through the battery module 1000 or each of the battery modules 1000 constituting the battery pack 2000.

The detection device may also detect a temperature of the battery cells 100 and/or the battery modules 1000 and/or an ambient temperature at at least one point in the battery pack 2000.

Although not shown in the drawings, the battery pack 2000 may include a balancing device. The balancing device may perform balancing operation of the battery modules 1000 and/or the battery cells 100 constituting the battery pack 2000. The control device (not shown) may receive the status information (voltage, current, temperature, and the like) of the battery modules 1000 from the detection device. The control device may monitor and calculate the state (voltage, current, temperature, state of charge (SOC), state of health (SOH), and the like) of the battery module 1000 based on the state information received from the detection device. The control device may also perform control functions (for example, temperature control, balancing control, charge/discharge control, and the like), protection functions (for example, over-discharge, over-charge, over-current protection, short-circuit, fire extinguishing functions, and the like), and the like, based on the state monitoring results. The control device may also perform wired or wireless communication with external devices of the battery pack 2000 (for example, a higher-level controller, a vehicle, a charger, PCS, and the like).

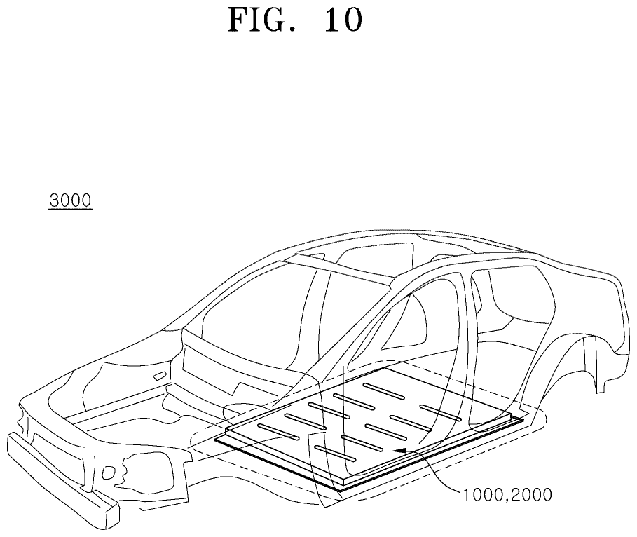

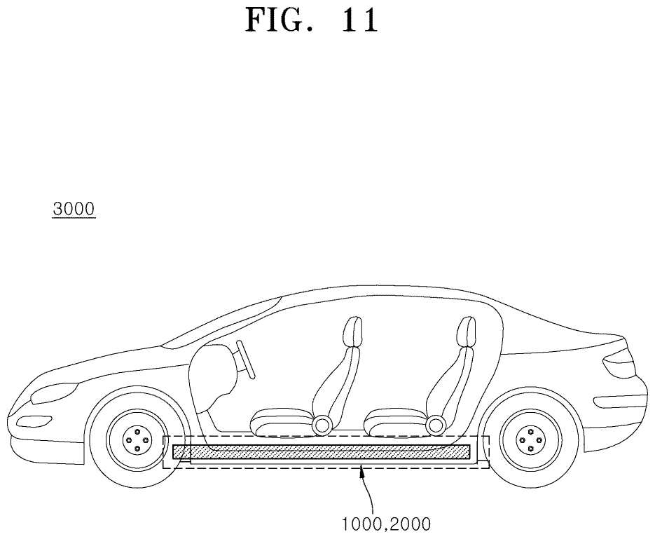

FIG. 10 is a perspective a view of a vehicle body and body parts according to an embodiment of the present invention; and FIG. 11 is a side view of the vehicle body and the body parts according to an embodiment of the present invention.

The battery pack 2000 according to the embodiment of the present invention illustrated in FIG. 8 and FIG. 9 may be mounted on an automobile 3000. The automobile 3000 may be, for example, an electric automobile, a hybrid automobile, or a plug-in hybrid automobile. The automobile 3000 may include a four-wheeled automobile or a two-wheeled automobile, for example.

As shown in FIGS. 10 and 11, the automobile 3000 according to an embodiment includes the battery module 1000 according to the embodiment of the invention and/or the battery pack 2000 including the battery module 1000. The automobile 3000 operates by receiving power from the battery module 1000 and/or the battery pack 2000 including the battery modules 1000 according to the embodiment of the present invention.

Although the present invention has been described with reference to some embodiments and drawings illustrating aspects thereof, the present invention is not limited thereto. Various modifications and variations can be made by a person skilled in the art to which the present invention belongs within the scope of the technical spirit of the invention and the claims and equivalents thereto.

What is claimed is:

1. A battery cell comprising:
an electrode assembly;
a case receiving the electrode assembly;
a cap plate coupled to an opening of the case;
a terminal arranged to the cap plate and electrically connected to the electrode assembly; and
an insulating member between the electrode assembly and the terminal.

2. The battery cell as claimed in claim 1, wherein
the electrode assembly comprises a first electrode; a second electrode different from the first electrode; and a separator between the first electrode and the second electrode, and
the terminal comprises a first terminal electrically connected to the first electrode through a first collector plate; and a second terminal electrically connected to the second electrode through a second collector plate.

3. The battery cell as claimed in claim 2, wherein the insulating member is between the first terminal and the first collector plate and/or between the second terminal and the second collector plate.

4. The battery cell as claimed in claim 1, wherein the insulating member comprises a through-hole through which the electrode assembly is electrically connected to the terminal.

5. The battery cell as claimed in claim 1, wherein a surface of the insulating member adjoins a surface of a collector plate at a side of the collector plate and has a cross-sectional area greater than or equal to a cross-sectional area of the surface of the collector plate.

6. The battery cell as claimed in claim 1, wherein the insulating member comprises at least one of mica, aerogel, silica, graphite, alumina, ceramic wool, and silicate.

7. The battery cell as claimed in claim 1, wherein the insulating member has a thickness of 0.8 mm to 2.0 mm.

8. A battery module comprising:
multiple battery cells;
a housing receiving the multiple battery cells; and
a busbar electrically connecting at least some of the multiple battery cells,
wherein each of the battery cells comprises:
an electrode assembly;
a terminal arranged under the busbar and electrically connected to the electrode assembly; and
an insulating member between the electrode assembly and the terminal.

9. The battery module as claimed in claim 8, wherein
the electrode assembly comprises a first electrode; a second electrode different from the first electrode; and a separator between the first electrode and the second electrode, and
the terminal comprises a first terminal electrically connected to the first electrode through a first collector plate; and a second terminal electrically connected to the second electrode through a second collector plate.

10. The battery module as claimed in claim 9, wherein the insulating member is between the first terminal and the first collector plate and/or between the second terminal and the second collector plate.

11. The battery module as claimed in claim 8, wherein the insulating member comprises a through-hole through which the electrode assembly is electrically connected to the terminal.

12. The battery module as claimed in claim 8, wherein a surface of the insulating member adjoins a surface of a collector plate at a side of the collector plate and has a cross-sectional area greater than or equal to a cross-sectional area of the surface of the collector plate.

13. The battery module as claimed in claim 8, wherein the insulating member comprises at least one of mica, aerogel, silica, graphite, alumina, ceramic wool, and silicate.

14. The battery module as claimed in claim 8, wherein the insulating member has a thickness of 0.8 mm to 2.0 mm.

15. The battery module as claimed in claim 8, further comprising an additional insulating member arranged in at least one region between the multiple battery cells.
